(19) United States
(12) Patent Application Publication
(10) Pub. No.: US 2012/0174990 A1
(43) Pub. Date: Jul. 12, 2012

(54) FLOW RATE RATIO CONTROLLING APPARATUS

(75) Inventor: Tadahiro YASUDA, Kobe-shi (JP)

(73) Assignee: HORIBA STEC, CO., LTD., KYOTO-SHI (JP)

(21) Appl. No.: 13/348,745

(22) Filed: Jan. 12, 2012

Related U.S. Application Data
(62) Division of application No. 12/809,836, filed on Jun. 21, 2010, now abandoned.

(30) Foreign Application Priority Data
Dec. 27, 2007 (JP) 2007-338257

(51) Int. Cl. G05D 11/13

(52) U.S. Cl. 137/101; 137/100; 137/101.19

(57) ABSTRACT

The flow rate ratio controlling apparatus comprises differential pressure flow rate controllers (MFC1, MFC2) of the same type and a control processing mechanism (C) for giving commands to the flow rate controllers (MFC1, MFC2) to control them. The flow rate controllers (MFC1, MFC2) are provided with respective branched flow channels (BL1, BL2) branched from a terminal of a main flow channel (ML) in opposite directions. The flow rate controller (MFC1) arranged in the branched flow channel (BL1) is operated so that a detected pressure achieves a predetermined target pressure; a target flow rate for the flow rate controller (MFC2) arranged in the branched flow channel (BL2) is determined from the total measured flow rate and the predetermined flow rate ratio, and the flow rate controller (MFC2) is operated so as to achieve the target flow rate.

### FIELD OF THE ART

This invention relates to a flow rate ratio controlling apparatus that divides a precursory gas used for a semiconductor manufacturing process at a desired ratio.

### BACKGROUND ART

Nowadays in a field of a semiconductor manufacturing process, a process chamber to house a wafer is also upsized because the wafer is upsized. In case of film forming the semiconductor wafer, it is preferable that a precursory gas for film forming is even. However, if the precursory gas is introduced to the upsized process chamber from one position alone, there might be a case that a concentration distribution becomes uneven.

Recently, a plurality of gas inlets are provided for the process chamber and from each of the gas inlets fed is the precursory gas whose mass flow rate ratio is controlled so that a gas concentration in the process chamber becomes even. At this time, as an apparatus to divide the precursory gas at a desired ratio, a flow rate ratio controlling apparatus is used.

Conventionally, as this kind of the flow rate ratio controlling apparatus, a method for dividing the precursory gas by the use of the pressure in each pipe is general. However, since this method does not directly control the ratio of the mass flow rate, an actual ratio of the mass flow rate is unclear.

Then as shown in the patent document 1 devised is a flow rate ratio controlling apparatus that conducts ratio control by measuring the mass flow rate. FIG. 5 shows an example of, especially, a bifurcated type of the flow rate ratio controlling apparatus. In FIG. 5, the code RXM is a main flow channel into which the gas flows. A pressure sensor 4X is arranged in the main flow channel RXM and its terminal is bifurcated. Flow meters 21X, 22X, and control valves 31X, 32X are arranged serially in each bifurcated branch channel RX1, RX2 respectively. Then a valve control section 5X both monitors flow rate data output from each flow meters 21X, 22X and pressure data output from the pressure sensor, controls the control valves 31X, 32X based on each of the flow data and the pressure data, and then controls the ratio of the mass flow rate of the gas flowing in each bifurcated branch channel RX1, RX2 (called as flow rate ratio) to a total flow rate so as to be the given set ratio. Concretely, the valve control section 5X conducts feedback-control on the control valve 31X of one bifurcated branched flow channel RX1 so that the value (also called as the actually measured pressure) of the pressure data becomes a previously determined certain target pressure. Then under a condition wherein the actually measured pressure is controlled near or over the target pressure, the valve control section 5X conducts feedback-control on the other control valve 32X so that a ratio of the value (also called as the actually measured flow rate) of the flow rate data to the total flow rate becomes the previously determined set ratio.

Patent document 1: Japan patent laid-open number 2005-38239

### DISCLOSURE OF THE INVENTION

### Problem to be Solved by the Invention

However, this type of the flow rate ratio controlling apparatus requires two types of devices such as a flow rate controller and a pressure controller.

In consideration of these problems, a main object of this invention is to provide a flow rate ratio controlling apparatus that does not require multiple types of devices so as to enable reduction of a number of types of component and a manufacturing cost.

### Means to Solve the Problems

In order to solve these problems the preset claimed invention takes the following measures.

More specifically, the flow rate ratio controlling apparatus of this invention comprises a differential pressure flow rate controller wherein a flow rate control valve to control a flow rate of a fluid flowing in an internal flow channel, a first pressure sensor, a fluid resistance, and a second pressure sensor are arranged serially in this order in the internal flow channel and that can measure the flow rate of the fluid based on the detected pressures detected by the first pressure sensor and the second pressure sensor, and a control processing mechanism that is arranged in the internal flow channel to give commands to the differential pressure flow rate controller to control it, and is characterized by that the differential pressure flow rate controller is arranged respectively in each of the multiple branched flow channels branched from a terminal of a main flow channel, for the flow rate controller arranged in one branched flow channel, the second pressure sensor is arranged to locate at an upstream side of the flow rate control valve, the first pressure sensor and the fluid resistance, and the flow rate controller is operated so that a detected pressure detected by the second pressure sensor achieves a previously determined target pressure, for the differential pressure flow rate controller arranged in the other branched flow channel, the flow rate control valve is arranged to locate at an upstream side of the first pressure sensor, the fluid resistance and the second pressure sensor, and a target flow rate to be flown in the differential pressure flow rate controller arranged in the other branched flow channel is calculated by the control processing mechanism based on a total measured flow rate output from all of the differential pressure flow rate controllers and a previously determined flow rate ratio, and the differential pressure flow rate controller is operated so as to achieve the target flow rate.

In accordance with this arrangement, since the identical type of the differential pressure flow rate controller is used for one branched flow channel and the other branched flow channel and the differential pressure flow rate controller arranged in one branched flow channel is operated so as to be the previously determined target pressure for one branched flow channel while the differential pressure flow rate controller arranged in the other branched flow channel is operated so as to be the target flow rate for the other branched flow channel, it is possible to control the mass flow rate ratio of the fluid flowing in each branched flow channel.

Furthermore, since only the identical type of the differential pressure flow rate controller is used, it is possible to reduce a type of the component constituting the flow rate ratio controlling apparatus, thereby reducing the manufacturing cost.

In addition, since only the differential pressure flow rate controller is used, it is possible to control the flow rate ratio of the fluid flowing in each branched flow channel more accurately on a constant basis compared with a case that the thermal mass flow meter is used even though a pressure change of the fluid flowing into the flow rate ratio controlling apparatus is big. Furthermore, since only the differential pressure flow rate controller is used, it is also possible to control the mass flow rate ratio with high accuracy even though an inlet side of the differential pressure flow rate controller and an outlet side thereof are at a negative pressure.

As another embodiment of the flow rate ratio controlling apparatus that can control the mass flow rate ratio of a fluid flowing in each branched flow channel with reducing a number of types of components together with high accuracy by using only the differential pressure flow rate controller of the identical type is used represented is a flow rate ratio controlling apparatus comprising a differential pressure flow rate controller wherein a first step pressure sensor, a flow rate control valve to control a flow rate of a fluid flowing in an internal flow channel, a first pressure sensor, a fluid resistance, and a second pressure sensor are arranged serially in this order in the internal flow channel and that can measure the flow rate of the fluid based on the detected pressures detected by the first pressure sensor and the second pressure sensor, and a control processing mechanism that is arranged in the internal flow channel to give commands to the differential pressure flow rate controller to control it and that is arranged in the internal flow channel, wherein the differential pressure flow rate controller is arranged respectively in each of the multiple branched flow channels branched from a terminal of a main flow channel, for the flow rate controller arranged in one branched flow channel, the differential pressure flow rate controller is operated so that a detected pressure detected by the first step pressure sensor achieves a previously determined target pressure, for the differential pressure flow rate controller arranged in the other branched flow channel, a target flow rate to be flown in the differential pressure flow rate controller arranged in the other branched flow channel is calculated by the control processing mechanism based on a total measured flow rate output from all of the differential pressure flow rate controllers and a previously determined flow rate ratio, and the differential pressure flow rate controller is operated so as to achieve the target flow rate.

### EFFECT OF THE INVENTION

In accordance with this invention having the above-mentioned arrangement, it is possible to control the mass flow rate ratio of the fluid flowing in each branched flow channel with high accuracy together with reducing a manufacturing cost by reducing a number of a type of the components because only the same type of the component is used.

### BRIEF DESCRIPTION OF THE DRAWINGS

FIG. 1 is a pattern general view showing a flow rate ratio controlling apparatus in accordance with a first embodiment of this invention.

FIG. 2 is a pattern view showing an internal structure of a flow rate controller of the first embodiment.

FIG. 3 is a pattern general view showing a flow rate ratio controlling apparatus in accordance with a second embodiment of this invention.

FIG. 4 is a pattern view showing an internal structure of a flow rate controller of the second embodiment.

FIG. 5 is a pattern general view showing a conventional flow rate ratio controlling apparatus.

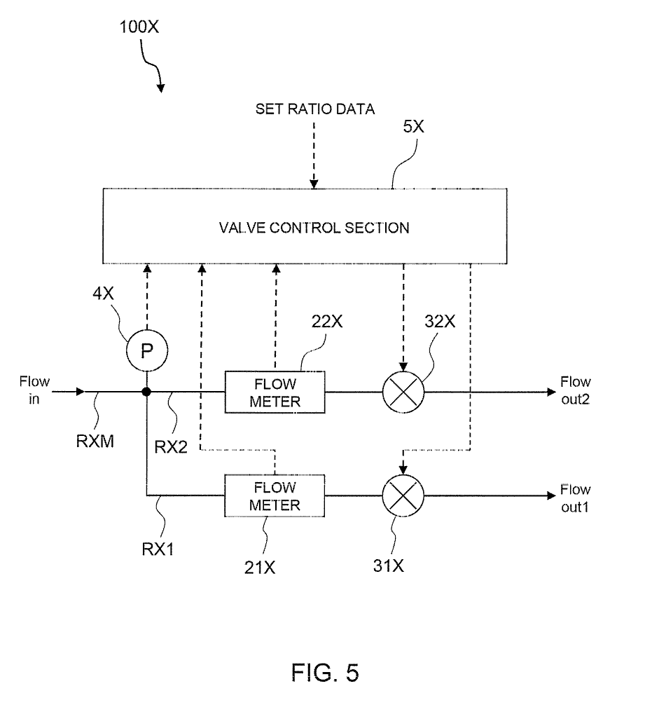

### EXPLANATION OF CODES

100 . . . flow rate ratio controlling apparatus
L1, L2 . . . internal flow channel
V1, V2 . . . flow rate control valve
P11, P12 . . . first pressure sensor
R1, R2 . . . fluid resistance
P21, P22 . . . second pressure sensor
MFC1, MFC2 . . . flow rate controller
C . . . control processing mechanism
ML . . . main flow channel
BL1, BL2 . . . branched flow channel
P01, P02 . . . first step pressure sensor

### BEST MODES OF EMBODYING THE INVENTION

A first embodiment of this invention will be explained with reference to drawings.

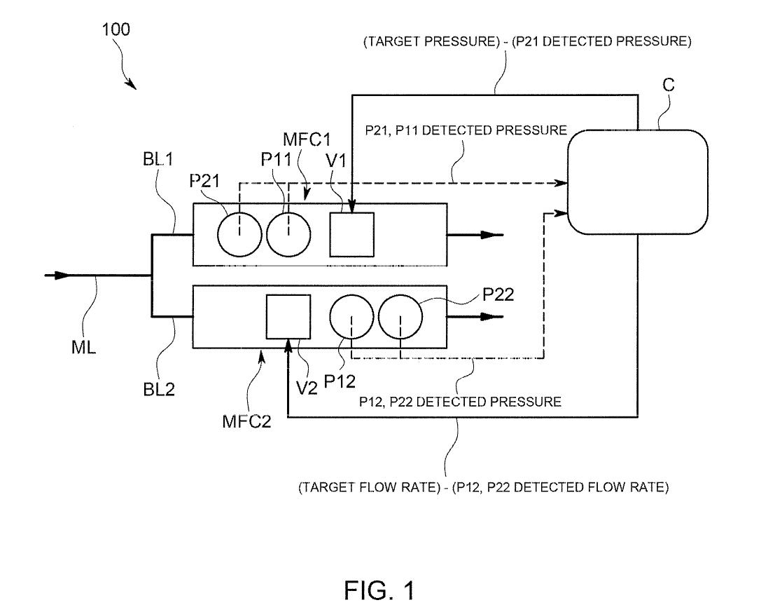

FIG. 1 is a pattern general view showing a flow rate ratio controlling apparatus 100 in accordance with this embodiment. The flow rate ratio controlling apparatus 100 divides, for example, a precursory gas for manufacturing semiconductors at a predetermined ratio and supplies the precursory gas to a semiconductor process chamber, and constitutes a part of a semiconductor manufacturing system, not shown in drawings. The flow rate ratio controlling apparatus 100 comprises mass flow controllers MFC1, MFC2 as being identical flow rate controllers and a control processing mechanism C to control the mass flow controllers MFC1, MFC2, and each of the mass flow controllers MFC1, MFC2 is arranged in each of the branched flow channels BL1, BL2 branched from a terminal of a main flow channel ML.

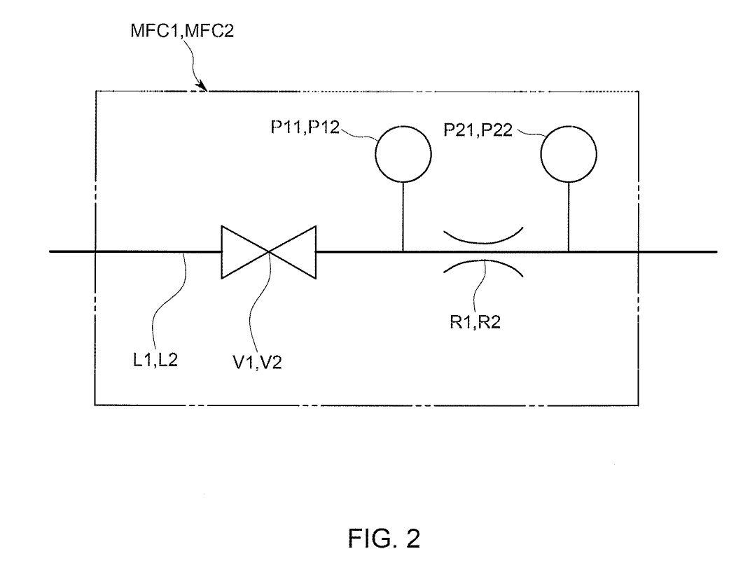

As shown in FIG. 2, the mass flow controller MFC1 (MFC2) has an arrangement that the flow rate control valve V1 (V2) to control a flow rate of a fluid flowing in an internal flow channel L1 (L2), a first pressure sensor P11 (P12), a fluid resistance R1 (R2), and a second pressure sensor P21 (P22) are arranged serially in this order. While an ordinal usage, a differential pressure generated in the vicinity of the fluid resistance R1 (R2) is detected by the first pressure sensor P11 (P12) and the second pressure sensor P21 (P22) and a mass flow rate of the fluid passing the fluid resistance R1 (R2) is calculated and used for controlling the flow rate control valve V1 (V2).

As shown in FIG. 1, the mass flow controller MFC1 is arranged in one branched flow channel BL1 in an opposite direction to an ordinary usage so that the second pressure sensor P21 locates in an upstream side, and the mass flow controller MFC2 is arranged in the other branched flow channel BL2 in the same direction as the ordinary usage so that the flow rate control valve V2 locates in an upstream side.

The control processing mechanism C comprises at least a CPU, a memory and various driver circuits as hardware and produces various functions in cooperation with the CPU and its peripheral devices according to a program stored in the memory.

Next, an operation of the flow rate ratio controlling apparatus 100 will be explained. For convenience of explanation, two mass flow controllers MSC1 and MSC2 are described separately as the first mass flow controller MFC1 and the second mass flow controller MFC2, however, the mass flow controllers MSC1 and MSC2 are of the completely identical mass flow controller.

For the first mass flow controller MFC1 wherein the second pressure sensor P21 is arranged in the upstream side, the control processing mechanism C conducts feedback-control on the flow rate control valve V1 of the first mass flow controller MFC1 by the use of the deviation between the pressure detected by the second pressure sensor P21 and a target pressure stored in the memory. In addition, the control processing mechanism C calculates the mass flow rate flowing in the internal flow channel L1 of the first mass flow controller MFC1 based on the pressure difference generated in the fluid resistance R1 detected by the second pressure sensor P21 and the first pressure sensor P11.

For the second mass flow controller MFC2 wherein the flow rate control valve V2 is arranged in the upstream side, the control processing mechanism C calculates the mass flow rate flowing in the internal flow channel L2 of the second mass flow controller MFC2 based on the pressure difference generated in the fluid resistance R2 detected by the first pressure sensor P12 and the second pressure sensor P22. Then the control processing mechanism C calculates a target mass flow rate to be flown in the second mass flow controller MFC2 based on the mass flow rate of the fluid flowing in each branched flow channel BL1, BL2 and a target flow rate ratio of each branch flow channel BL1, BL2 stored in the memory. The control processing mechanism C conducts feedback-control on the flow rate control valve V2 of the second mass flow controller MFC2 by the use of the deviation between the mass flow rate flowing in the internal flow channel L2 of the second mass flow controller MFC2 and the target mass flow rate.

In accordance with this arrangement, it is possible both to constitute the flow rate ratio controlling apparatus 100 using only the identical mass flow controller MFC1, MFC2, thereby reducing a manufacturing cost by reducing a number of a type of the components and also to control the flow rate ratio with high accuracy.

Furthermore, it is possible to control the flow rate ratio just with a very simple change of the mounting method such that one of the mass flow controllers MFC1, MFC2 is mounted in an opposite direction to an ordinary direction.

In addition, since the measurement of the mass flow rate is conducted by means of only the differential pressure type, even though a pressure change of the fluid flowing into the mass flow controller MFC1, MFC2 is big, it is possible to control the flow rate ratio with accuracy on a constant basis compared with a case of using a thermal type mass flow rate measurement method.

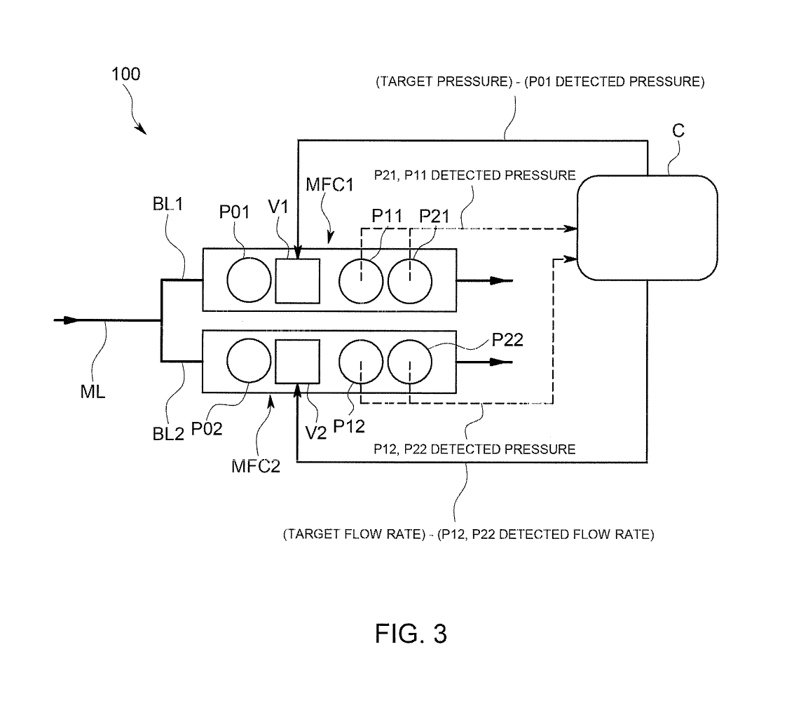

Next, a second embodiment of this invention will be explained with reference to FIG. 3. The same components corresponding to the first embodiment are denoted by the same reference numerals as those in the first embodiment.

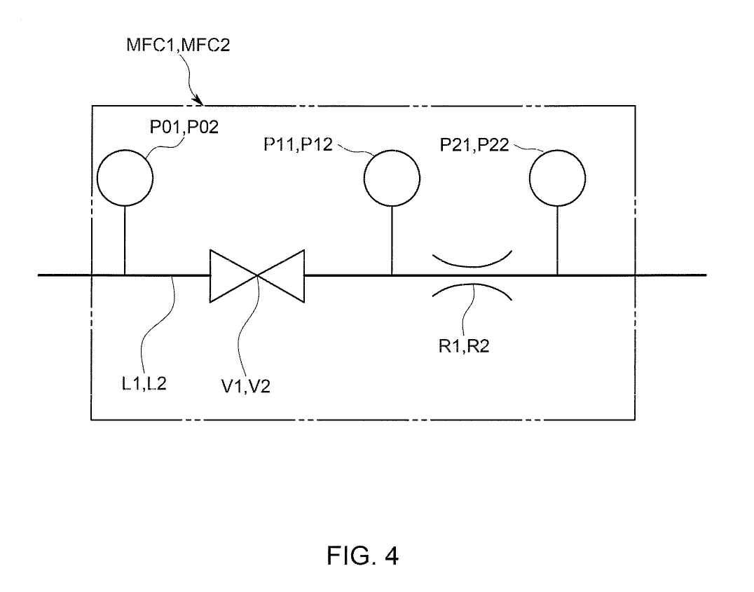

As shown in FIG. 4, each of the mass flow controllers MFC1, MFC2 as being the flow rate controller in this embodiment is so arranged that a first step pressure sensor P01, P02, a flow rate control valve V1, V2 to control the flow rate of the fluid flowing in the internal flow channel L1, L2, a first pressure sensor P11, P12, a fluid resistance R1, R2 and a second pressure sensor P21, P22 are arranged serially in this order in the internal flow channel L1, L2.

As shown in FIG. 3, the flow rate ratio controlling apparatus 100 of the second embodiment has an arrangement that each of the mass flow controllers MFC1, MFC2 is arranged so that the first step pressure sensor P01, P02 locates in the upstream side in the branched flow channel BL1, BL2 branched from the terminal of the main flow channel ML respectively, and comprises the control processing mechanism C to control the mass flow controllers MFC1, MFC2.

Next, an operation of the flow rate ratio controlling apparatus 100 will be explained. For convenience of explanation, two mass flow controllers MSC1 and MSC2 are described separately as the first mass flow controller MFC1 and the second mass flow controller MFC2, however, the mass flow controllers MSC1 and MSC2 are of the completely identical mass flow controller.

For the first mass flow controller MFC1, the control processing mechanism C conducts feedback-control on the flow rate control valve V1 of the first mass flow controller MFC1 by the use of the deviation between the pressure detected by the first step pressure sensor P01 and a target pressure stored in the memory. In addition, the control processing mechanism C calculates the mass flow rate flowing in the internal flow channel L1 of the first mass flow controller MFC1 based on the pressure difference generated in the fluid resistance R1 detected by the first pressure sensor P11 and the second pressure sensor P21.

For the second mass flow controller MFC2, the control processing mechanism C calculates the mass flow rate flowing in the internal flow channel L2 of the second mass flow controller MFC2 based on the pressure difference generated in the fluid resistance R2 detected by the first pressure sensor P12 and the second pressure sensor P22. Then the control processing mechanism C calculates a target mass flow rate to be flown in the second mass flow controller MFC2 based on the mass flow rate of the fluid flowing in each branched flow channel BL1, BL2 and a target flow rate ratio of each branched flow channel BL1, BL2 stored in the memory. The control processing mechanism C conducts feedback-control on the flow rate control valve V2 of the second mass flow controller MFC2 by the use of the deviation between the mass flow rate flowing in the internal flow channel L2 of the second mass flow controller MFC2 and the target mass flow rate.

In accordance with this arrangement, it is possible to control the mass flow rate ratio of each branched flow channel BL1, BL2 with high accuracy together with reducing a manufacturing cost by reducing a number of a type of the components. In addition, in case of this second embodiment, it is also possible to omit a process of changing the direction of the mass flow controllers MFC1, MFC2 and it is possible to arrange the identical mass flow controller MFC1, MFC2 in all of the flow channels.

In addition, since the measurement of the mass flow rate is conducted by means of only the differential pressure type, even though a pressure change of the fluid flowing into the mass flow controller MFC1, MFC2 is big, it is possible to control the flow rate ratio with accuracy on a constant basis.

The present claimed invention is not limited to the above-mentioned embodiment.

For example, a number of the branched flow channel is two, however, a further more number of flow channels may be provided. In this case, at least one of the mass flow controllers as being the flow rate controller arranged in each branched flow channel may control the pressure as a reference.

In the above-mentioned embodiment, one control processing mechanism is provided for all of the flow rate controllers, however, the control processing mechanism may be arranged for each flow rate controllers and each control processing mechanism may control the flow rate ratio cooperatively each other.

Furthermore, the present claimed invention can be applied not only to the semiconductor manufacturing process but also to other gas and a liquid, and in case it is applied to the gas and the liquid, the same action and effect can be produced as that of the above-mentioned embodiment.

In addition, the present claimed invention may be variously modified without departing from a spirit of the invention.

### POSSIBLE APPLICATIONS IN INDUSTRY

In accordance with this invention, it is possible for the flow rate ratio controlling apparatus both to reduce a number of a type of components so as to reduce a manufacturing cost and to control the mass flow ratio of the fluid flowing in each branched flow channel with high accuracy.

1. A flow rate ratio controlling apparatus comprising
a differential pressure flow rate controller wherein a flow rate control valve to control a flow rate of a fluid flowing in an internal flow channel, a first pressure sensor, a fluid resistance, and a second pressure sensor are arranged serially in this order in the internal flow channel and that can measure the flow rate of the fluid based on the detected pressures detected by the first pressure sensor and the second pressure sensor, and a control processing mechanism that is arranged in the internal flow channel to give commands to the differential pressure flow rate controller to control it, wherein
the differential pressure flow rate controller is arranged respectively in each of the multiple branched flow channels branched from a terminal of a main flow channel,
for the differential pressure flow rate controller arranged in one branched flow channel, the second pressure sensor is arranged to locate at an upstream side of the flow rate control valve, the first pressure sensor and the fluid resistance, and the differential pressure flow rate controller is operated so that a detected pressure detected by the second pressure sensor achieves a previously determined target pressure,
for the differential pressure flow rate controller arranged in the other branched flow channel, the flow rate control valve is arranged to locate at an upstream side of the first pressure sensor, the fluid resistance and the second pressure sensor, and a target flow rate to be flown in the differential pressure flow rate controller arranged in the other branched flow channel is calculated by the control processing mechanism based on a total measured flow rate output from all of the differential pressure flow rate controllers and a previously determined flow rate ratio, and the differential pressure flow rate controller is operated so as to achieve the target flow rate.
